(19) United States
(12) Patent Application Publication
(10) Pub. No.: US 2010/0109367 A1
(43) Pub. Date: May 6, 2010

(54) PAYLOAD DIVIDER SUPPORT ARMATURE

(76) Inventor: Robert Mihalko, Greensburg, PA (US)

Correspondence Address: METZ LEWIS, LLC, 11 STANWIX STREET, 18TH FLOOR, PITTSBURGH, PA, 15222, US

(21) Appl. No.: 12/263,723

(22) Filed: Nov. 3, 2008

(51) Int. Cl. B62D 33/02

(52) U.S. Cl. 296/43

(57) ABSTRACT

A partition support member is disclosed for placement on a trailer, truck bed or the like. A support member is provided to engage a preexisting cavity on said trailer or truck bed. At least one and preferably a series of channels are provided on the device so that a partition or partition support may be slidingly engaged thereto. A plurality of the devices may be used to support partitions to subdivide said truck bed or trailer.

### FIELD OF INVENTION

This invention relates to subdividing open payload spaces or vehicles. More particularly, the invention relates to providing support for a partition in the payload space of a flatbed truck or trailer.

### BACKGROUND AND DESCRIPTION OF PRIOR ART

The utility of the payload space of vehicles has been evident with the popularity of flatbed trucks and trailers. In particular the payload space of flatbeds and trailers has allowed for a wide array of payloads of various shapes and sizes to be able to be carried. Because of the open nature of the payload space of flatbed trucks and trailers, restraining devices such as ropes, chains, and winches have been employed to secure payloads and maximize the utility of the payload space.

Although the prior means have been effective for loads that are able to be secured by ropes, chains, winches and the like, loads that cannot be secured by these means, such as mulch, stone and topsoil have not been able to be effectively carried by flatbed trucks and trailers without being placed in a prior container. Moreover, it may be necessary to carry a multiplicity of items which requires specific payload spaces. Lastly the payload space has further utility if small items may be restrained in a controlled space.

It would therefore maximize the utility of the payload space of flatbed trucks and trailer if the payload space could be partitioned to divide separate loads and allow for the containing of particulate loads such as mulch and stone. Additionally utility would be maximized if the ability to partition the payload space was highly customizable and easily put together and taken apart.

Therefore, the object of this invention is to provide structural support to partitions of a payload space that are highly customizable and easy to put together and take apart.

Previous attempts to increase the utility of payload spaces of vehicles have principally focused on pick-up trucks. The particular shortcomings of many of these devices is that they do not allow for the variable customization and ease of use that that would maximize the utility of the payload areas.

Bronstein, U.S. Pat. No. 3,677,562 issued Jul. 18, 1972 relates to a pick-up load holding device which contains vertical stakes designed for reception into stake pockets and a cross beam for traversing the load area to which the loads may also be secured. The cross beam may either be permanently affixed to stakes or may be collapsible by connecting to the stake through the use of a collar. Additional height may be obtained by the stakes if they are provided with telescopic extensions.

Tuerk, U.S. Pat No. 4,231,606 issued Nov. 4, 1980 relates to a pickup truck stake arrangement wherein a delta shaped stake is inserted into the side wall pockets of a pickup truck bed. The stakes contain a dovetail groove which accepts the dovetail ridge of a partition panel receiving bracket. At the bottom of the delta shaped stakes is a plastic plug with a rounded projection used to plug a drain hole that is commonly found in the bottom of pickup truck side wall pockets.

Cloutier, et al., U.S. Pat. No. 4,236,748 issued Dec. 2, 1980 relates to a stake for a truck bed, trailer or truck structure. The stakes are of a triangular shape that contain L and U shaped channels integrated unto the stake to accept panels. The stakes insert into pockets along the perimeter of the flatbed. The top of the stakes contain a thickened facing to form a circle that may receive a bowed circular rod.

Porter, U.S. Pat. No. 6,077,007 issued Jun. 20, 2000 relates to a pick-up truck bed organizer and method. The invention consists of a plurality of telescoping tubular supports that join with a pickup truck's bed to form a frame for supporting payloads within the bed. The tubular supports attach vertically to the truck bed floor and horizontally between the vertical supports.

Wayne, U.S. Pat. No. 6,478,356 issued Nov. 12, 2002 relates to a cargo area structure that divides a truck bed into compartments. The invention consists of a truck bed liner having slots built into the walls of the liner to hold dividers and divide the cargo area.

Kelter, U.S. Pat. No. 7,017,997 issued Mar. 28, 2006 relates to a truck with bed partition wherein the partition panels can be kept in a depression in the bed floor and then pivoted into a vertical position and locked into the truck's sidewall.

The deficiency with the prior art is that all these devices do not allow for easy implementation because they either require previous existing structure on the vehicle or are permanently fixed such that they lack versatility. The object of the present invention is to allow for an easy means of constructing a partition in a payload space that is highly versatile and does not require undue modification to the vehicle itself.

### SUMMARY OF THE INVENTION

The trailer bracket that is the present invention allows for the structural support of a partition across the payload space of a vehicle. A U shaped channel is provided to receive and restrain a partition which may be placed in the channel and held in an upright position. The trailer bracket may be fixed to which the vehicle either by fitting into a preexisting side wall pocket or being mechanically fastened to the vehicle's frame. Flatbed truck and trailer payload space commonly has such side wall pockets to implement the present invention. If the vehicle does not have pockets, the trailer bracket can be attached by drilling into the frame of the vehicle to allow for the bracket to be attached with a fastener which is a common means of implementation for other truck and trailer after-market parts.

The trailer bracket is constructed from a light weight rigid durable material such as aluminum or steel. The bracket is constructed as a singular unit such that it is affordable to create a partitioning system with a plurality of brackets and a partition which could be made of any material such as wood or plywood. The bracket may be embodied such that multiple channels can be affixed to the mounting member of the bracket to allow support of partitions in the transverse and parallel directions of the payload space. Additionally, the channels may contain a notch along the bottom edge so that they may fit over a side wall fence of a trailer or flatbed payload space.

An additional advantage of the trailer bracket is that it allows for a vertical member to be received and restrained in the top portion of the device. This can allow for an additional bracket to be placed and restrained above the first bracket to allow additional vertical support members such as a 2″×4″ to be restrained and more support given to vertical dividers or partitions. This also increases the ability to carry greater loads such as mulch, rock and soil.

### BRIEF DESCRIPTION OF THE DRAWINGS

FIG. 1 is an isometric view of the invention, in its principal embodiment.

FIG. 2 is an isometric perspective view of the invention in its principal embodiment being implemented.

FIG. 3 is a side view of the invention viewed from mounting member end to the receiving member end.

FIG. 4 is an isometric view of an alternative embodiment of the invention.

FIG. 5 is a second isometric view of the alternative embodiment of the invention.

### DETAILED DESCRIPTION OF THE PREFERRED EMBODIMENTS

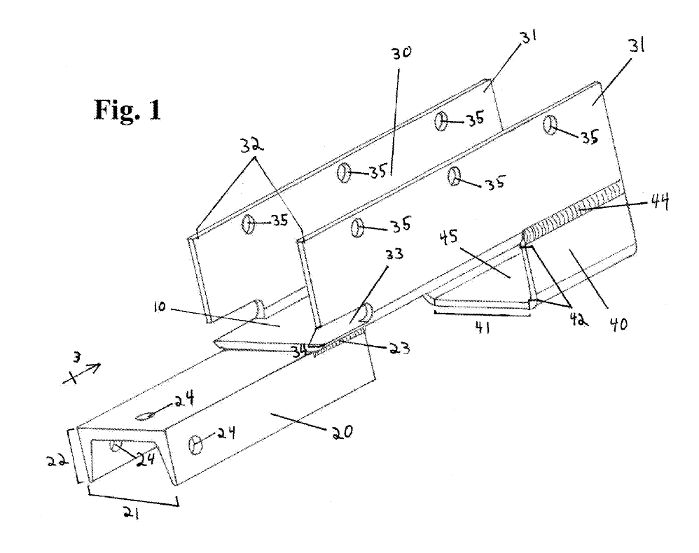

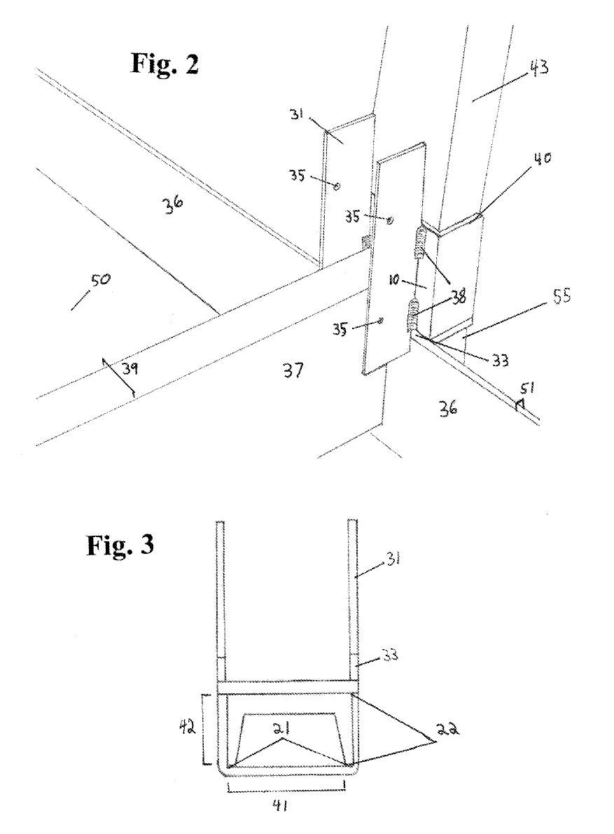

The principal embodiment of the present invention is illustrated in FIGS. 1, 2, 3. The device is given structural support through a primary support member 10. Affixed to the primary support member are a mounting member 20, a channel 30, and a receiving member 40.

The mounting member 20 has a length 21 and a width 22 such that it will fit within a side wall pocket of a flatbed or trailer 55. The mounting member 20 may be welded at 23 thereby affixing the mounting member 20 to the primary support member 10. Additionally, mounting member 20 may be affixed from the open side or eliminated entirely and primary support member 10 be utilized alone. Should side wall pockets 55 not be available or additional support required, the mounting member 20 may contain circular openings 24 to allow for mechanical fasteners such as screws, bolts, rivets, nails and the like to fix the mounting member 20 to the vehicle frame.

The channel 30 contains two sidewalls 31 which serve to receive and restrain partition 37 preferably in a sliding engagement. The side walls 31 may either be formed of a single sheet of metal formed into a U shape or they maybe be welded at 38 as separate components to the primary support member 10. The side walls 31 are situated a distance 32 apart such that the distance 32 is greater than the partition's width 39. A payload space 50 may be enclosed by a trailer wall fence 36 or may contain another kind of obstruction. In order that side walls 31 provide support to partition 37 below the height of an obstruction such as the trailer wall fence 36 a notch 33 is required. The notch is of a width 34 that is greater than the width 51 of the trailer wall fence 31. The side walls 31 may contain circular openings 35 to allow for mechanical fasteners such as screws, bolts, rivets, nails and the like to fix the partition 37 to the channel 30.

The receiving member 40 forms a pocket 45 having a length 41 and a width 42. The receiving member 40 is welded at 44 to the primary support member 10. The receiving pocket 45 may receive any vertical member such as 2″×4″ plank that may fit inside of the pocket. The length of the receiving pocket 41 and width 42 are of such size that they are at least greater than the mounting member's length 21 and width 22 such that the mounting member 20 may fit inside of the receiving member 40. The receiving member 40 may also receive a vertical support member 43.

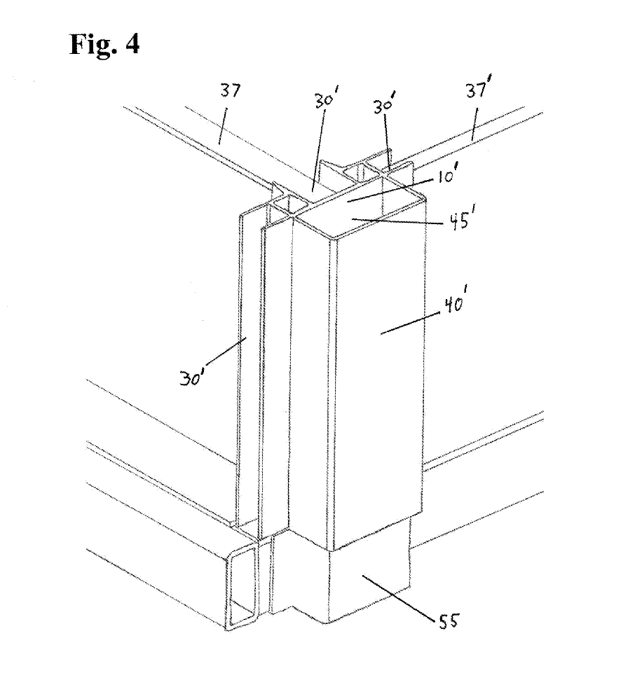

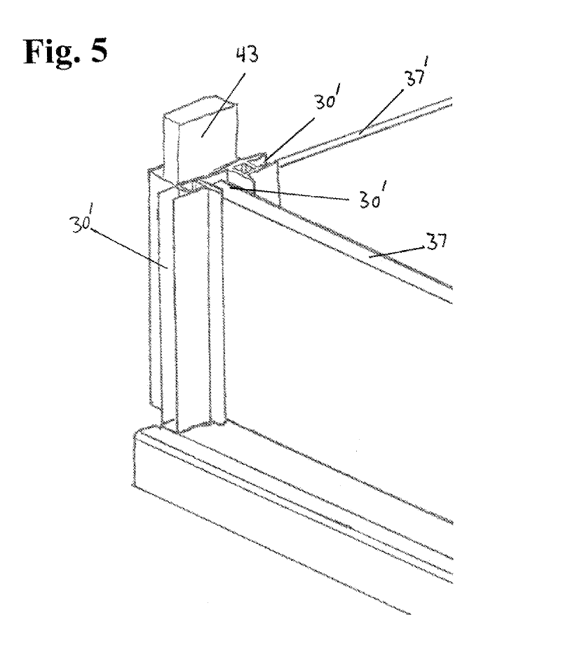

FIG. 4 and 5 illustrate alternative embodiments of the invention. The invention is seated in the side wall pocket 55. The embodiment is made of a singular construction and contains a primary support member 10′, a mounting member (not shown), a plurality of channels 30′, and a receiving member 40′, all of which are integrated into a single unit. A partition 37 which is in the transverse position and a partition 37′ in the parallel position are supported by the channels 30′. The receiving member 40′ contains a pocket 45′ which can receive a vertical member, such as a vertical support member 43.

What is claimed:

1. A device for providing support to a partition within a payload space of a vehicle comprising:
a primary support member;
a mounting member affixed to said primary support member for supporting the device in a preexisting restraint cavity;
a channel affixed to said primary support member for receiving and restraining a partition;
a receiving member affixed to said primary support member for receiving and restraining a vertical member.

2. A device according to claim 1 further comprising:
said channel having a shape that it contains a notch where said channel would engage a mounting obstruction such that said channel may support said partition and engage said obstruction within said notch.

3. A device according to claim 1 further comprising:
said vertical member being a vertical support member.

4. A device according to claim 1 further comprising:
said vertical member being a mounting member of a second device.

5. A device according to claim 1 further comprising:
said mounting member containing circular openings for mechanical fasteners.

6. A device according to claim 1 further comprising:
said channel containing openings for mechanical fasteners.

7. A device according to claim 1 further comprising:
a plurality of said channels affixed to said primary support member.

8. A device according to claim 7 further comprising:
said plurality of channels which are affixed in parallel orientations.

9. A device according a claim 7 further comprising:
said plurality of channels affixed in transverse orientations.

10. A device according to claim 7 further comprising:
said plurality of channels affixed in both parallel and transverse orientations.

11. A device according to claim 1 wherein:
said device is constructed of a rigid material.

12. A device according to claim 1, wherein:
said primary support member is rectangular in section.

13. A device according to claim 1 wherein:
said vertical support member is a 2″×4″ plank.

14. A device according to claim 1 wherein:
said partition is constructed of plywood sheeting.

15. A device according to claim 1 wherein:
said device slidingly engages said preexisting restraint cavity.
